(19) United States
(12) Patent Application Publication
(10) Pub. No.: US 2005/0285312 A1
(43) Pub. Date: Dec. 29, 2005

(54) Use of PMOD materials in layered (3D) manufacturing technology

(76) Inventors: Michael A. Fury, San Francisco, CA (US); Leo G. Svendsen, Leonia, NJ (US)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 10/876,087

(22) Filed: Jun. 23, 2004

(51) Int. Cl. B29C 35/08

(52) U.S. Cl. 264/401; 264/494

(57) ABSTRACT

The invention generally encompasses a method for producing a three-dimensional layered structure comprising at least one layer of a metal-containing material in order to provide functionality. The method comprises sequentially forming each of a plurality of layers, wherein each layer of the plurality of layers has predetermined dimensions, and wherein at least one of the layers comprises a metal-containing material. The plurality of layers is stacked to create an integral three-dimensional layered structure with predetermined dimensions.

### BACKGROUND OF THE INVENTION

1. Field of the Invention

This invention relates to methods for introducing functionality into layered manufacturing structures by inserting patterned metal-containing materials. More particularly, the methods of the present invention relate to forming three-dimensional layered structures comprising metal-ligand complexes using a combination of stereolithography and photochemical/photothermal metal organic deposition.

2. Description of the Related Art

Layered manufacturing is a method of creating three-dimensional structures by forming the structure one layer at a time. The purpose of the method is to quickly create a part or assembly that can be used as a vehicle for visualization or serve as the final part. Layered manufacturing decreases development time, since corrections can be recognized and made to a product early in development while such corrections may be made inexpensively. Currently, commercially available layered manufacturing processes include stereolithography, selective laser sintering, laminated object manufacturing, fused deposition modeling, solid ground curing and ink jet printing. Each of these processes include the steps of obtaining a mathematical description of the three-dimensional structure, which is often derived from a computer-aided design (CAD) model; converting the three-dimensional mathematical description into a series of two-dimensional mathematical descriptions representing a plurality of layers; and forming and stacking each layer until the three-dimensional structure is complete.

The most widely used layered manufacturing method is stereolithography. Stereolithography is inexpensive compared to most other techniques and uses a light-sensitive liquid polymer. The layers are formed by polymerizing a light-sensitive liquid polymer, which is a photoreactive material that solidifies when exposed to a sufficient amount of energy. Stereolithography creates a three-dimensional layered structure one layer at a time on a platform that is immersed in a vat of photoreactive material. The platform is positioned below the surface of the photoreactive material, and energy, usually energy that is focused by a laser, is moved across the surface of the photoreactive material to create a layer of polymerized photoreactive material. After a layer is formed, the platform is lowered, and the next layer is formed. The process is repeated until the three-dimensional layered structure is created and often includes a subsequent step to complete the solidification of the structure. Also, adjacent layers can be fused together by directing energy focused by a laser through an overlying layer into an adjacent underlying layer and polymerizing the layers together. Supports may be used in stereolithography to provide strength to the structure during its formation. The supports can be designed from the mathematical description of the structure and are removed after creation of the structure is complete.

Early applications of stereolithography enabled quick fabrication of molds and prototypes from CAD drawings to identify deficiencies before committing a design to expensive large scale production. More recently, stereolithography has been used to create objects that are either relatively inexpensive or only needed in small amounts, which do not justify the cost of developing a full-scale manufacturing process. Although the fundamental principles have not changed, intricate geometries, such as tunnels and passageways, can now be built into a single solid structure using stereolithography, whereas conventional manufacturing methods are unable to provide such structural intricacy in a single process. Furthermore, methods of building around working mechanisms are being developed to provide functionality to three-dimensional layered structures and expand the application of stereolithography. A. Kataria, et al. Proceedings of DETC '00, 2000 ASME Design Engineering Technical Conferences and Computers and Information in Engineering Conference, Baltimore, Md., Sep. 10-13, 2000. The fundamental elements of stereolithography are described in U.S. Pat. Nos. 4,575,330 and 5,495,058, each of which is incorporated by reference herein in its entirety.

The art of stereolithography has experienced a need to create three-dimensional layered structures with enough functionality to serve as a marketable product rather than simply a model, prototype or single component requiring additional processing to introduce such functionality. Incorporation of materials other than the basic photopolymer can provide functionality and obviate the need for additional processing to produce a functional structure. For example, metal containing materials can introduce functionality and provide structures such as conductors, insulators, reflectors, springs, hinges and other electrical or mechanical components. Currently, however, materials other than the basic photopolymer must be physically placed or inserted into a structure to gain the functionality associated with that material. In many cases, such placement may be difficult and expensive, if not impossible. Thus, the art of stereolithography would benefit from a method of incorporating functionality into three-dimensional layered structures.

### SUMMARY OF THE INVENTION

The invention generally encompasses a method for producing a three-dimensional layered structure comprising at least one layer of a metal-containing material in order to provide functionality. In one embodiment, the method comprises sequentially forming each of a plurality of layers, wherein each layer of the plurality of layers has predetermined dimensions, and wherein at least one of the layers comprises a metal-containing material. The plurality of layers is stacked to create an integral three-dimensional layered structure with predetermined dimensions. By use of the present invention, functionality can be introduced into three-dimensional layered objects by incorporating materials other than the basic photopolymer, thereby reducing or eliminating the need for additional processing to produce a functional structure.

### BRIEF DESCRIPTION OF THE DRAWINGS

FIG. 1 illustrates a process for forming a layer comprising a metal-ligand complex on a substrate using photochemical/photothermal metal organic deposition according to one embodiment of the present invention;

FIG. 2 illustrates a stereolithography apparatus according to one embodiment of the present invention; and

FIG. 3 illustrates the creation of a three-dimensional layered structure comprising a metal-containing material according to one embodiment of the present invention.

### DETAILED DESCRIPTION OF THE PREFERRED EMBODIMENTS

As discussed in more detail below, the invention generally comprises a method for producing a layered three-dimensional structure, wherein one or more layers comprise a polymer and a metal-containing material. A plurality of layers are formed sequentially and stacked to form a three-dimensional layered structure with predetermined dimensions, and each layer within the plurality of layers has predetermined dimensions as well. Further, at least one of the layers comprises a metal-containing material, which may be formed from a precursor material comprising a metal-ligand complex.

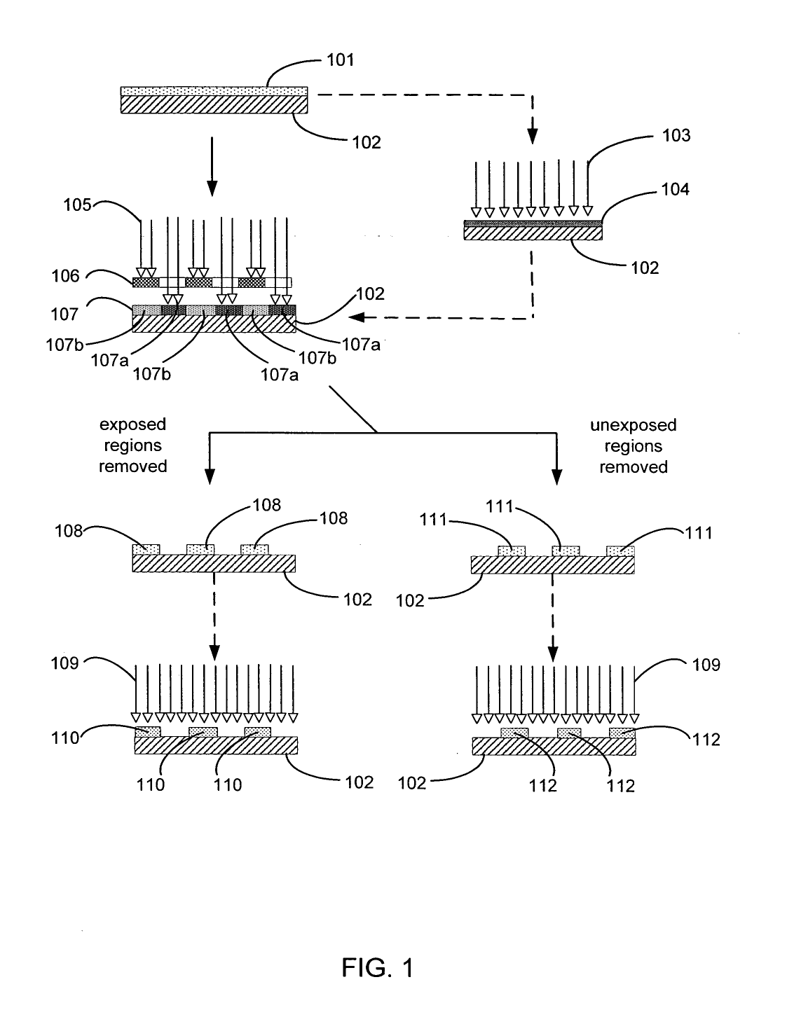

FIG. 1 illustrates a process for forming a layer comprising a metal-ligand complex on a substrate using photochemical/photothermal metal organic deposition according to one embodiment of the present invention. In a first step, a precursor comprising at least one metal is applied to a substrate 102 to form a precursor layer 101. The precursor is a metal-ligand complex. Generally, the precursor is selected based upon a desired end-use of a final pattern of metal-containing material. For example, the desired end-use may require that the final pattern of metal-containing material provide a desired property such as conductivity, dielectric constant, breakdown voltage, mechanical stress, shrinkage, densification, and thickness.

As will be discussed below, the precursor is exposed to energy in order to alter the solubility characteristics of predetermined regions of the precursor, thereby allowing certain portions of the precursor to be removed while other portions remain and constitute the final pattern of metal-containing material. Accordingly, the precursor is also selected based upon its change in solubility characteristics before and after exposure to energy. In one embodiment, the precursor should be capable of being developed or solubilized in a developer after exposure to a sufficient amount of energy. In other words, the precursor, after being exposed to energy, should be generally soluble in a developer so that it can be removed from a substrate. In addition, the unexposed precursor should be generally insoluble in the same developer. In another embodiment, the precursor should be generally incapable of being developed or solubilized in a developer after exposure to a sufficient amount of energy. In other words, the precursor, after being exposed to energy, should be generally insoluble in a developer so that it will remain on a substrate. In addition, the unexposed precursor should be generally soluble in the same developer. It should be appreciated that the choice of precursor will affect the degree of solubility in a given developer that is observed after exposure to energy; however, as will be discussed in more detail below, a preferred developer should maximize the solubility differences between the unexposed precursor and the exposed precursor in order to allow for selective removal of predetermined portions of the precursor. The characteristic of a developer to allow for selective removal of predetermined portions of the precursor is referred to as the selectivity of the developer.

As noted, the precursor comprises a metal-ligand complex that comprises at least one metal, which is preferably bound to at least one ligand. The metal in the precursor may be any metal, metalloid, compound of a metal or metalloid including oxides, sulfides, ceramics, alloys, organometallics and coordination compounds.

Examples of the metals encompassed by the present invention include, for example, Li, Na, K, Rb, Cs, Fr, Be, Mg, Ca, Sr, Ba, Ra, Sc, Y, La, Ac, Ti, Zr, Hf, Unq, V, Nb, Ta, Unp, Cr, Mo, W, Unh, Mn, Tc, Re, Uns, Fe, Ru, Os, Co, Rh, Ir, Ni, Pd, Pt, Cu, Ag, Au, Zn, Cd, Hg, Al, Ga, In, Ti, Sn, Pb, Bi, any other element within the Lanthanide or Actinide series, and Si, Ge, As, Sb, Te, and Po. In one embodiment, the metals may be, for example, any combination of the metals encompassed by the present invention.

In another embodiment, the metals may be, for example, Pt, Au, Ag, Cu, Pd, Ni, or a combination thereof. In another embodiment, the metals may be, for example, Nb, Ta, Hf, Sc, Y, Al, or a combination thereof. In another embodiment, the metals may be, for example, Y, La, Ce, Pr, Nd, Pm, Sm, Eu, Gd, Tb, Dy, Ho, Er, Tm, Yb, Lu, or a combination thereof. In another embodiment, the metals may be, for example, Ac, Th, Pa, U, Np, Pu, Am, Cm, Bk, Cf, Es, Fm, Md, No, Lr, or a combination thereof. In another embodiment, the metals may be, for example, Li, Na, K, Rb, Cs, Fr, Be, Mg, Ca, Sr, Ba, Ra, or a combination thereof. In another embodiment, the metals may be, for example, Re, Rh, Ru, Ir, or a combination thereof. In another embodiment, the metals may be, for example, In, Sn, or a combination thereof. In yet another embodiment, the metals may be, for example, Pb, Bi, or a combination thereof.

In a preferred embodiment, the metals may be, for example, Ti, Zr, Mn, Pb, Pt, Au, Nb, Ta, Cr, Fe, Co, Ni, or a combination thereof. In a more preferred embodiment, the metals may be, for example, Co, Ni, Fe, or a combination thereof. In an even more preferred embodiment, the metals may be, for example, Ti, Zr, or a combination thereof. In a most preferred embodiment, the metal may be, for example, Ti.

The precursor of the present invention can be molecular, meaning that the metal-ligand complexes have not been subjected to appreciable hydrolysis. Hydrolysis becomes appreciable when the molecular precursor (or metal-ligand complex) begins to form a sol, meaning that particles (“sol particles”) have formed in the precursor as a result of hydrolysis. Hydrolysis can be controlled, for example, by limiting the water content and temperature of the precursor. The preferred method to obtain and maintain a molecular precursor (or metal-ligand complex) is to keep the water content of the precursor low enough to avoid appreciable hydrolysis. However, the precursor of the present invention may also be a sol. The sol particles that form within the precursor through hydrolysis can be, for example, microparticles, nanoparticles, or a combination thereof.

The precursor of the present invention may also comprise non-sol particles that did not form in the precursor as a result of hydrolysis. The non-sol particles can be surrounded by at least one ligand and may also be, for example, microparticles, nanoparticles, or a combination thereof. In one embodiment, the non-sol particles are ceramics. In another embodiment, the non-sol particles are alloys. In another embodiment, the non-sol particles may comprise a combination of alloys and ceramics.

In a further embodiment, the precursor may comprise sol particles and non-sol particles. Examples of how particles may be used with the present invention are included in U.S. patent application Pub. No. 2002/0018861 A1, which is incorporated by reference herein in its entirety.

As noted above, the precursor is a metal-ligand complex preferably comprising at least one metal bound to at least one ligand. Generally, the ligand is used to make the precursor layer 101 a stable, or at least metastable, layer, meaning that the precursor layer 101 must not uncontrollably decompose during processing or under process conditions. The stability of the precursor layer may depend on the oxidation state of the metal in the complex. For example, most Ni(0) complexes are known to be unstable in air while Ni(II) complexes are stable in air. Accordingly, the stability of a process for depositing Ni-based materials in an air atmosphere could be controlled by using a Ni(II) complex rather than a Ni(0) complex.

In addition, the ligand is selected to preferably make the precursor layer 101 amorphous. Crystallinity within the precursor layer impedes diffusion of reaction byproducts created during exposure out of the precursor layer (e.g., volatile organic species that diffuse out of the precursor layer) and adversely hinders the resolution of the resulting pattern of metal-containing material. In addition, crystalline films tend to exhibit lower reaction quantum yields than amorphous films as a result of the restricted motion of groups within the crystal.

To provide such a stable or metastable amorphous precursor, the precursor may comprise one or more ligands or combination of ligands. For example, several different ligands may be attached to each metal atom to provide asymmetry within the precursor layer. Also, ligands with two or more stereoisomeric forms, such as racemic 2-ethylhexanoate, provide asymmetry within the precursor layer. The presence of several isomers within the precursor layer impairs crystallization without affecting the desired properties of the precursor layer. Additionally, a low polarity precursor with low intermolecular forces may be desirable and, as such, may preferably comprise ligands with peripheral organic groups. Specific examples of preferred ligands comprise the following structures:

β-diketones (for example, “acac” or 2,4-pentanedione and substituted acetylacetone), which comprise the general formula 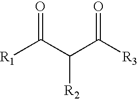
and their anionic forms;

γ-diketones (for example, 2,5-hexanedione and substituted acetonylacetone), which comprise the general formula 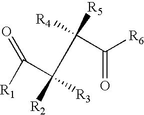
and their anionic forms;

dialkyldithiocarbamates, which comprise the general formula 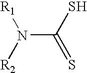
and their anionic forms;

carboxylic acids, which comprise the general formula 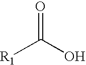
such as hexanoic acid where R₁═CH₃(CH₂)₄, and their anionic forms;

carboxylates, which comprise the general formula 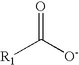
such as hexanoate where R₁═CH₃(CH₂)₄, and their anionic forms;

pyridine and/or substituted pyridines, which comprise the general formula

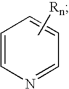

arsines, which comprise the general formula

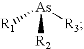

diarsines, which comprise the general formula

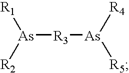

phosphines, which comprise the general formula

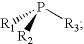

diphosphines, which comprise the general formula

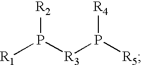

arenes, which comprise the general formula

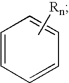

and other structures such as azide (N₃⁻); amines, which comprise the general formula NR₁R₂R₃; diamines, which comprise the general formula R₁R₂NR₃NR₄R₅; hydroxy groups (OH⁻); alkoxy ligands, which comprise the general formula R₁O⁻; ligands such as (C₂H₅)₂NCH₂CH₂O—; alkyl and aryl ligands; or a combination thereof.

With respect to the above metal-ligand complexes or precursors, each functional group R within groups R₁ through Rₙ, wherein n represents the number of substitution sites, is independently selected from H, alkenyl, alkyl, aralkenyl, aralkyl, aryl, and various other groups as defined below:

The term “alkenyl” refers to a straight or branched hydrocarbon chain where at least one of the carbon-carbon linkages is a carbon-carbon double bond. The phrase straight chain or branched chain hydrocarbon chain means any substituted or unsubstituted acyclic carbon-containing compounds including alkanes, alkenes and alkynes.

The term “alkyl” refers to a straight or branched hydrocarbon chain. Examples of alkyl groups include lower alkyl, for example, methyl, ethyl, n-propyl, iso-propyl, n-butyl, iso-butyl, tert-butyl or iso-hexyl; upper alkyl, for example, n-heptyl, -octyl, iso-octyl, nonyl, decyl, and the like; lower alkylene, for example, ethylene, propylene, propylyne, butylene, butadiene, pentene, n-hexene or iso-hexene; and upper alkylene, for example, n-heptene, n-octene, iso-octene, nonene, decene and the like. Persons of ordinary skill in the art are familiar with numerous straight and branched alkyl groups, which are within the scope of the present invention. In addition, such alkyl groups may also contain various substituents in which one or more hydrogen atoms is replaced by a functional group or an in-chain functional group.

The term “aralkenyl” refers to an alkenyl group which is terminally substituted with at least one aryl group.

The term “aralkyl” refers to an alkyl group which is terminally substituted with at least one aryl group such as, for example, benzyl.

The term “aryl” refers to a hydrocarbon ring bearing a system of conjugated double bonds, often comprising at least six π (pi) electrons. Examples of aryl groups include, but are not limited to, phenyl, naphthyl, anisyl, toluyl, xylenyl and the like.

As used herein, the term “functional group” refers to a chemical structure possessing in-chain, pendant and/or terminal functionality. Examples of in-chain functional groups include ethers, esters, ketones, amides, urethanes and their thio-derivatives (at least one oxygen atom is replaced by a sulfur atom). Examples of pendant and/or terminal functional groups include, but are not limited to, halogens such as fluorine and chlorine; hydrogen-containing groups such as hydroxy, alkoxy, epoxy, carboxyl, carbonyl, amino, amido, thio, isocyanato, cyano; and ethylenically unsaturated groups such as allyl, acryloyl and methacryloyl, and maleate and maleimido.

In a preferred embodiment, the precursor comprises at least one ligand selected to comprise one or more of the following structures and functional groups: acac, carboxylato, alkoxy, azides, amines, halides, carbonyl, nitrato, nitro, and any combination thereof including anionic forms. In addition, the precursor comprises at least one metal selected from the group consisting of Li, Al, Si, Ti, V, Cr, Mn, Fe, Ni, Co, Cu, Zn, Sr, Y, Zr, Nb, Mo, Ru, Rh, Pd, Ag, In, Sn, Ba, La, Pr, Sm, Eu, Hf, Ta, W, Re, Os, Ir, Pt, Au, Pb, Th, U, Sb, As, Ce, Mg, and any combination thereof.

As noted above, the precursor should be capable of being converted to a form that differs in solubility from its original form after being exposed to a sufficient amount of energy. For this conversion to occur, at least one ligand should be reactive. Upon exposure to energy, the precursor may undergo photochemical and/or photothermal reactions that produce intermediate products that are preferably unstable and capable of either spontaneously converting to the desired form or to volatile reaction byproducts that diffuse through and dissipate from the precursor layer. Accordingly, the desired photochemical and photothermal characteristics of the precursor can be enhanced by, for example, including ligands in the precursor that promote formation of the desired reaction products. An example of such ligands used to achieve the desired reaction products through photothermal reaction include, for example: acetylenes (R₁CCR₂); amines; aquo (H₂O); azides; β-diketones (R₁(CO)CHR₂(CO)R₃); γ-diketones (R₁(CO)CR₂R₃CR₄R₅(CO)R₆); carbonato (CO₃⁻²); carbonyl (CO); cyano (CN⁻); dihydride (H₂); ethylene(H₂CCH₂) and substituted forms thereof (R₁R₂CCR₃R₄); halides; hydride (H⁻); hydrogen; hydroxy (OH); isothiocyanato (NCS⁻); nitrate (NO₃); nitrato (NO₃⁻); nitrito (NO₂⁻); nitro (NO₂); nitrosyl (NO); oxalato 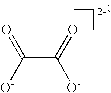
OXO (O₂⁻); thiocarbonyl (CS); thiocyanato (SCN⁻); and groups. Each functional group R within groups R₁ through Rₙ, wherein n represents the number of substituted atoms, is independently selected, and preferably, is independently selected from H, alkyl, aryl, alkenyl, aralkyl and aralkenyl groups. Even more preferably, each ligand is independently selected to comprise one or more of the following structures and functional groups: acac, oxalato, carboxylato, alkoxy, azides, amines, halides, carbonyl, nitrato, nitro groups and any combination thereof including anionic forms. It should be appreciated that such ligands may also be combined with other ligands, including those described previously. Other exemplary precursors, including metal-ligand complexes, are described in U.S. Pat. No. 5,534,312, which is incorporated by reference herein in its entirety.

While the precursor 101 may be applied to the substrate 102 alone, the precursor may also be mixed with a casting solvent to solubilize the precursor for ease of application onto the substrate 102. The casting solvent may be chosen based on several criteria, including its environmental impact, reactivity and purity, wherein purity considerations include, but are not limited to, isomeric purity and the presence of metal ions. Other physical characteristics of the casting solvent may also be taken into account, including the solubility limit of the precursor; oxygen and other gases in the casting solvent; the viscosity and vapor pressure of the combined casting solvent and precursor; the ability of the casting solvent to diffuse through a subsequently formed film; and the thermal stability of the casting solvent. In addition, the spectral characteristics of the casting solvent are an important design consideration because a casting solvent spectra that can easily be subtracted from a spectra of a precursor layer can facilitate identification of structural changes in the precursor layer. Knowledge of such structural changes aids in designing the process to achieve operational goals. Standard chemical spectral analyses used in identifying structural changes include, but are not limited to, UV, visible, IR, NMR, electron beam, ion beam and x-ray spectroscopy techniques such as XPS and ESCA. Furthermore, a casting solvent's influence on secondary reactions such as the initiation of nucleation in a subsequently formed film should also be considered in selecting a casting solvent. Exemplary casting solvents include, but are not limited to, the alkanes, and in particular, the hexanes; the ketones, and in particular, methyl isobutyl ketone (“MIBK”) and methyl ethyl ketone (“MEK”); and propylene glycol monomethyl ether acetate (“PGMEA”).

The substrate 102 may be any material that is compatible with the precursor layer 101 such that the reactions required for pattern formation are not adversely affected. The substrate 102 can be an underlying layer used in the formation of a three-dimensional layered structure or merely a platform used to support the precursor layer during pattern formation from which the pattern of metal-containing material can be later transferred. For example, where substrate 102 is an underlying layer, the metal-containing material can adhere to the substrate, and any differences in coefficients of expansion should be sufficiently small to avoid product failure with normal variations in temperature. The substrates include, but are not limited to, printed and/or laminated circuit board materials, which may be flexible and include, but are not limited to, plastics. Although plastics and other organic substrates provide certain advantages such as flexibility, the disadvantage of using plastics and other organic substrates is that they can be damaged by the relatively high process temperatures of conventional deposition methods. The relatively low process temperatures that may be used with the present invention such as, for example, ambient temperatures, are thus beneficial in the application of plastics and other organic substrates. Preferred substrate materials include photopolymers and metal-containing materials such as metal-organics and, more particularly, metal-ligand complexes.

It should be appreciated that the choice of substrate is not critical to the process but may affect other design considerations such as the choice of casting solvent and method of applying the precursor. As such, the substrate may require preparation prior to applying the precursor. Substrate preparations include, for example, a simple cleaning of the surface of the substrate, applying a barrier material, applying an adhesion promoting material, applying a reactive material such as a coupling agent, and a combination thereof.

Methods of applying the precursor 101 to the substrate 102 may include, for example, spinning, spraying, dipping, roller coating, stamping, meniscus coating, and various inking approaches such as inkjet-type application. The method used will depend upon the particular step in the layered manufacturing process and the three-dimensional structure formed. However, the preferred method will be dipping the substrate into a vat of precursor material. The variables in the process of applying the precursor may be altered to control the properties of the precursor layer. Examples of such properties are, for example, the thickness, smoothness and uniformity of the precursor layer. Control of process variables may, for example, minimize the formation of edge effects, voids and pinholes in the film; and reduce the amount of precursor used. For example, the concentration of the precursor in the casting solvent can be varied over a wide range, and chemical additives can be added, to control properties such as, for example, photosensitivity, viscosity, uniformity, rate of precursor layer formation and resistance of the precursor layer to cracking during conversion.

In a second step, predetermined portions of the precursor layer 101 are exposed to energy 105 in order to produce an exposed precursor layer 107 having both exposed regions 107a and unexposed regions 107b, wherein the exposed regions 107a correspond to the predetermined portions of the precursor layer 101 that were exposed to the energy 105. The predetermined portions are selected by identifying the pattern that is desired for that layer of metal-containing material, wherein the desired pattern may represent a single two-dimensional mathematical description in a series of two-dimensional mathematical descriptions that directly correspond to a series of layers that must be formed and stacked to create a three-dimensional layered metal-containing structure. The exposure of such predetermined portions of the precursor layer 101 results in those portions being converted to exposed regions 107a, which are either soluble or insoluble in a developer, depending on whether the process is designed to develop or solubilize exposed regions 107a or unexposed regions 107b in a subsequent developing step.

The energy 105 converts those predetermined portions of the precursor layer 107 by photochemical reaction, photothermal reaction, or a combination thereof. Examples of energy 105 capable of converting the precursor layer 107 in this manner include, for example, heat, electromagnetic radiation, electron beam, ion or charged particle beam, neutral-atom beam, and chemical energy. Electromagnetic radiation may include light and can be broadband or in specific wavelengths. In a preferred embodiment the light is ultraviolet light including, but not limited to, light in the wavelength range of from about 150 nm to about 600 nm and, most preferably, the wavelength range of from about 157 nm to about 436 nm.

The predetermined portions of the precursor layer 101 may be selectively exposed using a focused beam of energy in a rasterizing process. In another embodiment, a mask 106 may be used that permits the energy 105 to strike only the predetermined portions of the precursor layer 107. In another embodiment, the entire surface of the precursor layer 107 may be exposed to energy, wherein a mask is not used.

It should be appreciated that any means, such as, for example, flooding, printing, writing, or a combination thereof, may be used to expose the precursor layer 107. There are a variety of ways to direct energy 105 and include, but are not limited to, a collimation apparatus, a laser diode or a reflector system. Irrespective of the means chosen to direct the energy, a sufficient amount of energy 105 should be applied to the precursor layer 107 to ensure that the exposed regions 107a are sufficiently converted to a form that differs in solubility from its original form. It should also be appreciated that over-conversion of regions 107a should be avoided, since over-conversion can result in the creation of an insoluble extended-solid/extended-oxide network that is difficult, if not impossible, to develop.

Optionally, the process may include pre-exposing (as shown by the dashed lines in FIG. 1) the precursor layer 101 to energy 103 such that the precursor layer 101 is partially converted into a partially-converted precursor layer 104 prior to exposure to energy 105. In this optional step, energy 105 is still required to complete conversion of exposed regions 107a and to obtain the requisite solubility difference between regions 107a and 107b.

The pre-exposing step may be used for any number of reasons including, but not limited to, increasing productivity and reducing manufacturing cost. Numerous precursor layers can be partially converted with a cheaper source of energy 103 and then fully converted in less time by exposing them to energy 105 in a subsequent step. An example of a cheaper source of energy to use in the optional pre-exposing step is an ultraviolet lamp. In another example, multi-component precursors may be designed such that each component converts at a predetermined level of energy, which allows for more control of the manufacturing process. Accordingly, step-wise conversion can, for example, save on equipment cost, increase equipment life, reduce energy consumption, and increase the amount of product produced in a given amount of time. Further, any casting solvent remaining in the precursor layer after applying the precursor to the substrate may be removed using a pre-exposing step. In this case, the energy 103 is applied such that the temperature of the precursor layer is maintained below its thermal decomposition temperature. Methods of step-wise conversion are described in U.S. patent application Publ. No. US2002/0037481 A1, which is incorporated by reference herein in its entirety.

It should be appreciated that pre-exposure can create a variety of structural changes in the precursor. For example, pre-exposing the precursor not only reduces the dose of energy 105 required but also partially converts the precursor layer. As such, pre-exposure can alter properties of the precursor layer such as conductivity, nucleation, speciation, and crystallization, as well as anneal the precursor layer for uniformity. Therefore, an understanding of how pre-exposure affects the properties of the precursor layer can provide further flexibility to the process. In one example, the precursor material can be removed in steps or plated using methods known by those of skill in the art. In this example, partially converted areas may serve as nucleation sites for plating and allow for the addition of other materials. In another example, the pattern of metal-containing material can be used as a mask for implantation to selectively add other materials to an underlying material. Examples of how masks may be used with the present invention are included in U.S. patent application Pub. No. 2002/0076495 A1, and U.S. Pat. No. 5,534,312, each of which is incorporated by reference herein in its entirety.

In one embodiment, exposed regions of the precursor are removed. After exposure to energy 105, the exposed regions 107a are developed, thereby producing a patterned precursor layer or pattern 108, which comprises the unexposed regions 107b remaining on the substrate 102. Specifically, a developer is added to the precursor layer to selectively solubilize and remove the exposed regions 107a and, thus, selectively develop those portions of precursor layer 101 that were exposed to a sufficient amount of energy 105. The developer selectively removes the exposed regions 107a of the precursor layer 107 rather than the unexposed regions 107b that were not exposed to a sufficient amount of energy 105.

In another embodiment, unexposed regions of the precursor are removed. After exposure to energy 105, the unexposed regions 107b are developed, thereby producing a patterned precursor layer or pattern 111, which comprises the exposed regions 107a remaining on the substrate 102. Specifically, a developer is added to the precursor layer to selectively solubilize and remove the unexposed regions 107b and, thus, selectively develop those portions of precursor layer 101 that were not exposed to a sufficient amount of energy 105. The developer selectively removes the unexposed regions 107b of the precursor layer 107 rather than the exposed regions 107a that were exposed to a sufficient amount of energy 105.

The choice and relative effectiveness of the developer will depend on process conditions used during conversion such as the type of precursor; the type and amount of exposure and pre-exposure energies 105, 103 used for converting the precursor layer 101; and the temperature and the atmosphere in which conversion takes place. Generally, these factors affect the polarity of the precursor upon conversion, which, in turn, drives the selection of a developer.

One of skill in the art has access to scientific literature and data regarding the solubility of metal-organic compounds and will appreciate that the choice of developer depends upon the nature of both the exposed and unexposed regions 107a, 107b. Furthermore, one of skill in the art will appreciate that the choice of developer may begin empirically by calculating the Gibb's free energy of dissolution using available thermodynamic data. It is also recognized that the kinetics of dissolution will be important in selecting the developer.

Developers may also be identified and selected by exposing unconverted precursor layers to different types of energy, different amounts of energy, and a combination thereof; and using standard techniques to identify changes in structure and physical properties of the precursor layer during exposure to different amounts of energy. For example, spectral analysis can be used to identify functional group changes in the molecular structure. Potential developers can be identified, evaluated and selected knowing these structural changes.

The developer generally comprises a polar or non-polar solvent that will selectively solubilize either exposed or unexposed regions of the precursor. The developer may be a polar or protic solvent such as water, alcohol, or a weak acid, or the developer may be a non-polar solvent such as an alkane. The developer may also comprise an amphiphilic solvent containing both polar and non-polar functionality. Developers may be in the form of a liquid or a solution, and dry development methods that are analogous to dry patterning may also be used. Preferred methods of development include spray, puddle, and immersion application techniques. It should be appreciated that the selectivity of a developer may be limited such that areas of the precursor layer 107 that are intended to remain undeveloped are subject to an even removal or thinning.

The type of precursor applied to the substrate may also affect the choice of developer, since the molecular structure within a precursor and its response to exposure to energy varies according to the type of precursor. For example, it is recognized that when a precursor layer is applied, the molecular structure within the precursor layer may associate, typically through bridging ligands. In one example, the molecules within a molecular precursor can associate through bridging ligands other than O²⁻ ions such as, for example, CO₂. In another example, the molecules within a sol precursor can form associations between metals through bridging O²⁻ ions and, accordingly, form a gel. These molecular associations can be initiated, accelerated, or disrupted in subsequent process steps such as, for example, exposing the precursor layer to energy, thus affecting the relative compositions of the converted and unconverted precursor materials and, accordingly, the choice of developer.

The polarity of the exposed and unexposed regions of the precursor may also be a factor considered in selecting a developer. Obtaining the requisite solubility may require, inter alia, that the developer's polarity and the polarity of the exposed precursor be appropriately matched to allow for such solubilization. For example, the converted precursor layer 107 may comprise non-polar organic fragments. In this case, potential developers useful to remove the non-polar fragments would not include higher polarity solvents such as water, but rather, would include lower polarity solvents such as, for example, long-chain or branched-chain alcohols.

The atmosphere in which conversion takes place can be varied to control the properties of the precursor layer such as polarity. As such, the atmosphere in which conversion takes place may be controlled in conjunction with the selection and use of a particular developer. In one example, an oxidizing environment may be preferred if the pattern is to comprise metal oxides. In this example, air may be used as the oxidizing atmosphere for conversion, since it is economical, but air may not be suitable for all precursors or all end-uses of the pattern. In another example, a reducing environment may be preferred if the precursor layer is to comprise reduced metals as opposed to metal oxides. Reducing environments may comprise, for example, nitrogen, hydrogen, inert gases or a vacuum. In another example, it may be desirable to control the humidity of the atmosphere to regulate the amount of water in the precursor layer.

It should also be appreciated that the process can be designed such that either the exposed or unexposed regions are developed. In one example, a developer will preferably remove unexposed regions 107b without removing exposed regions 107a. If the exposed regions comprise an amorphous metal-oxide, produced as a result of conducting the exposure in air, and the unexposed regions are not oxides, then the preferred developer may be non-polar aprotic solvents such as hexane, hexenes, methylene chloride, chlorinated solvents, MIBK, ketones, esters and ethers. In this example, the process could be reversed and the exposed regions comprising metal-oxides could be developed using a high polarity solvent.

Casting solvents may also be used as developers, alone or in combination with other developers, particularly in embodiments where the exposure to energy converts the precursor to an insoluble form. However, casting solvents can also be used in embodiments where the exposure to energy converts the precursor to a soluble form. For example, the unconverted precursor layer may oligomerize or polymerize during coating and change the kinetics of dissolution of the unconverted material such that the solubility of the unconverted material in the casting solvent has decreased significantly. Exposure of the precursor layer to energy may then break weak polymeric bonds and create smaller fragments in the converted regions of the film that are soluble in the casting solvent. Although the polarity of the exposed and unexposed regions may be similar, the kinetics of dissolution may favor removal of the shorter fragments in the exposed regions. Surprisingly, these shorter fragments may be best removed with a casting solvent.

Optionally, the process may include post-exposing the pattern 108 to energy 109 to further alter the physical properties of the pattern 108 and form a final pattern of metal-containing material 110. As with the pre-exposing and exposing steps described above, the properties of pattern 108 can be altered by photochemical reactions, photothermal reactions, or combinations thereof. Such post-exposure may be performed for many reasons including, but not limited to, changing the structure of the chemical bonds within pattern 108. For example, energy from a thermal source, a laser, or a plasma source may be used to anneal the pattern 108 or, in other words, to change the pattern 108 from an amorphous material to a semi-crystalline material or crystalline material. Accordingly, the physical properties of the pattern 108 may be finely-tuned by post-exposing the pattern 108 to energy 109 for a particular end-use.

It should be appreciated that additional patterns of metal-containing material with predetermined dimensions can be formed and stacked on top of pattern 108 to create a three-dimensional layered structure. The post-exposing step may be used to adhere such a stack of layers together to create an integral three-dimensional layered structure comprising metal-containing material.

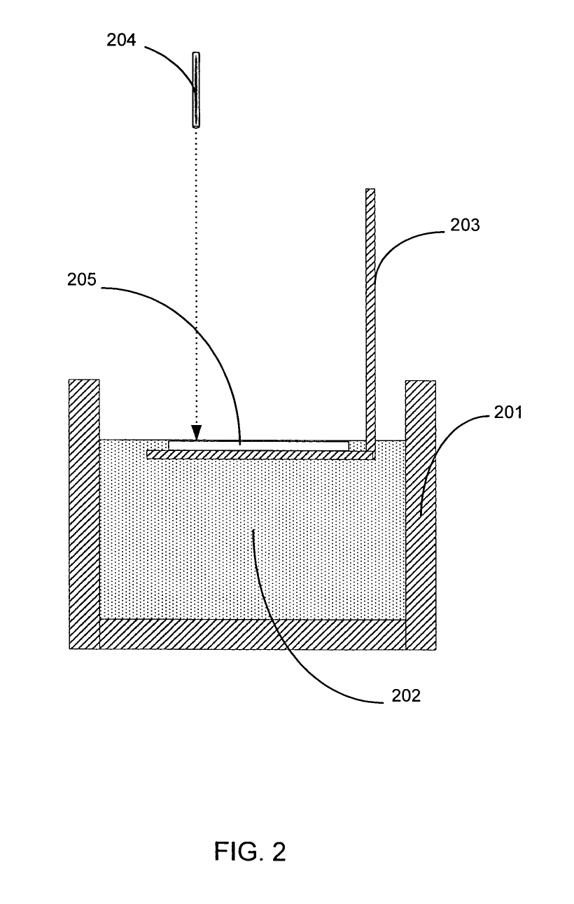

FIG. 2 illustrates a stereolithography apparatus according to one embodiment of the present invention. In this embodiment, a three-dimensional layered structure having predetermined dimensions can be created by forming and stacking a plurality of layers with predetermined dimensions. A mathematical description of a three-dimensional shape of an object can be obtained with the aid of a computer-aided design (CAD) model, and this three-dimensional mathematical description can then be separated into a series of two-dimensional mathematical descriptions that directly correspond to the plurality of layers that must be formed and stacked to create the three-dimensional layered structure.

In this embodiment, each layer within the three-dimensional layered structure is formed by converting a photoreactive material 202 with energy 204 from a laser that traces the shape of the layer 205. The three-dimensional layered structure is created by stacking each layer onto a previously formed, or underlying, layer.

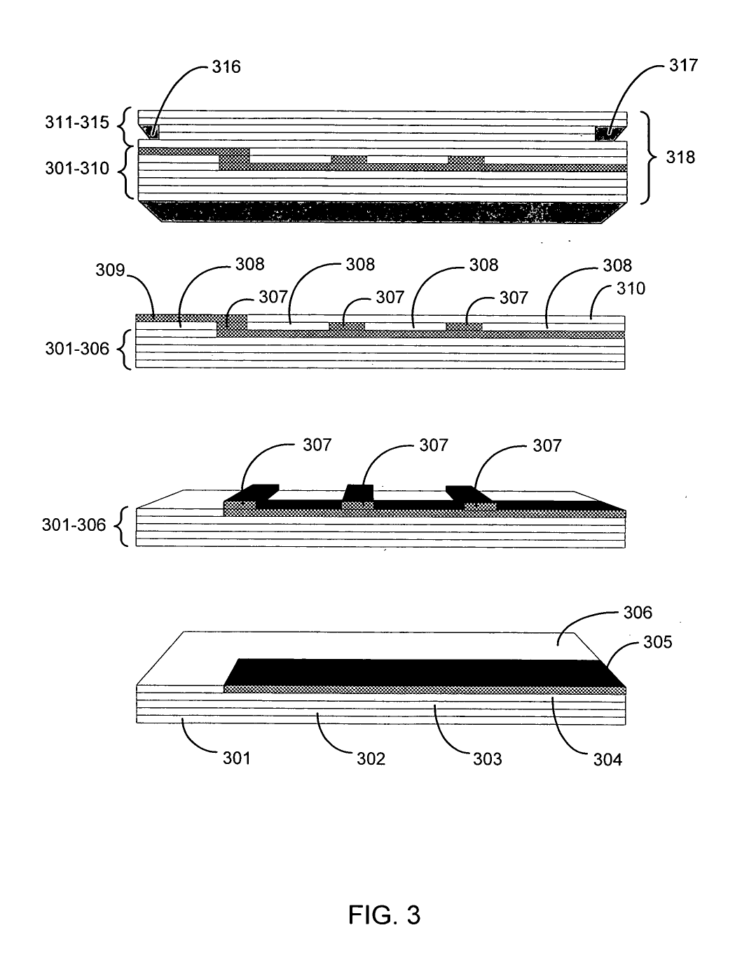

The process involves dipping a platform 203 into a vat 201 to a predetermined depth of photoreactive material 202 and exposing the photoreactive material 202 with energy 204 to polymerize the photoreactive material 202 and form a layer 205 with predetermined dimensions. The platform 203 is then lowered again to a predetermined depth to form another layer on top of the previously formed layer 205, where the previously formed layer 205 then serves as an underlying layer, or substrate, upon which the next layer is formed. The process is repeated until a plurality of layers has been formed and stacked, thus creating a three-dimensional layered structure with predetermined dimensions. It should be appreciated that, as will be described below in relation to FIG. 3, the use of more than one vat can provide a variety of photoreactive materials within the three-dimensional layered structure.

The photoreactive material 202 may need to be smoothed by a recoating device such as a doctor blade or applicator blade after lowering platform 203 in order to form a uniform layer of the desired thickness. Although layer thicknesses are generally, but not limited to, 0.020 inches or less, thinner layers provide higher resolution in the shape of the completed three-dimensional layered structure. A shape with higher resolution is smoother with less noticeable stepping between the plurality of layers. An additional benefit of the present invention is that the layers comprising a metal-ligand complex may be 1/10 the thickness of layers currently produced using basic photopolymer materials, thus providing a three-dimensional shape with higher resolution than currently available.

The photoreactive material 202 includes, but is not limited to, acrylates, epoxies, vinyl ethers and the metal-ligand complexes of the present invention described above. The formation of the plurality of layers occurs due to free-radical polymerization, cationic polymerization, or a combination thereof. The acrylates react quickly by free-radical polymerization when exposed to ultraviolet (UV) radiation but tend to shrink, warp and curl. The epoxies react by cationic polymerization and show less shrink, warp and curl than the acrylates and are the most common commercially available photoreactive materials used in a stereolithography apparatus. Examples of commercially available epoxy-based photoreactive materials include CIBA® SL5140, CIBA® SL5170, SOMOS® 9100, SOMOS® “FIT FORM FUNCTION”™ 9120, SOMOS® WATERCLEAR™ 10120, SOMOS® WATERSHED™ 11100 and SOMOS® RAVEN™7620.

The energy 204 includes, but is not limited to, electromagnetic radiation such as visible light, UV radiation, x-rays, gamma rays and thermal energy. Energy from electron beams, ion or charged particle beams, and neutral atom beams can also be used. One preferred energy source provides UV radiation. Another preferred energy source provides an electron beam. Examples of UV lasers useful in the practice of the present invention include, but are not limited to, helium-cadmium (HeCd) lasers, Nd—YVO₄ lasers and Argon-ion lasers. A preferred energy source is capable of producing a spot of energy 204 that is small enough to provide sufficient structural detail and intense enough to polymerize the photoreactive material 202 within a practical amount of time. The spot of energy 204 can be moved across the surface of photoreactive material 202 by any suitable programmable mechanism used by one of skill in the art of computer-aided manufacturing (CAM) to form a plurality of layers with predetermined dimensions. It should be appreciated that the energy 204 can be from a variety of sources known to one of skill in the art and can be unfocused, collimated or masked to define the shape of the layer 205.

The energy 204 used must exceed the critical exposure (C_{E}), which is a characteristic of the photoreactive material 202, to achieve polymerization. For example, when applying focused energy 204 from a laser, the power of the laser and the speed at which the laser moves across the surface of the photoreactive material 202 affect the ability of the laser to achieve C_{E}. The laser also has a depth of penetration (D_{P}) for a given photoreactive material 202, and this depth of penetration will always exceed the depth of the cured or polymerized material (C_{D}), because the energy 204 of the laser beam attenuates with penetration to a level insufficient to polymerize the photoreactive material 202 beyond C_{D} within the given exposure time. The process should be designed such that the energy 204 from the laser penetrates not only the layer 205 being formed but also the underlying layer previously formed such that the layers adhere to one another, thus creating an integral three-dimensional layered structure.

FIG. 3 illustrates the creation of a three-dimensional layered structure comprising a metal-containing material according to one embodiment of the present invention. After the formation of layer 301, the process of layer formation is repeated to stack layer 302 on layer 301, layer 303 on layer 302, layer 304 on layer 303, and so on until the formation of the three-dimensional layered structure is complete.

Metal-containing layer 305 is formed from a photoreactive material that comprises a metal-ligand complex, which is a different photoreactive material than the photoreactive material in the stacked layers 301-304. The formation of the metal-containing layer 305 on the stacked layers 301-304 may be accomplished using, for example, the following two methods: the photochemical/photothermal metal-organic deposition method as described in relation to FIG. 1 or the stereolithography apparatus method as described in relation to FIG. 2. Irrespective of which method is used, care should be taken to avoid cross-contamination between the different photoreactive materials. In one example, stacked layers 301-304 are removed from a stereolithography vat such as the vat taught in FIG. 2 and rinsed with a solvent capable of solubilizing unpolymerized photoreactive material without solubilizing polymerized photoreactive material.

The principles described above in relation to FIG. 1 for selecting a developer are the same principles used in selecting a solvent capable of solubilizing unpolymerized photoreactive material without solubilizing polymerized photoreactive material. The emphasis, again, is on the selectivity of the solvent. It should be appreciated that the selectivity of the solvent may be limited such that areas of the stacked layers that are intended to remain unsolubilized are subject to some removal or thinning.

Examples of solvents suitable for selectively rinsing away unpolymerized non-metal-containing photoreactive materials from their polymerized form include, but are not limited to, tripropylene glycol monomethyl ether (TPM) and a combination of propylene carbonate followed by isopropyl alcohol (IPA), both of which are suitable for rinsing unpolymerized SOMOS® “FIT FORM FUNCTION”™ 9120, SOMOS® WATERCLEAR™ 10120 and SOMOS® RAVEN™ 7620. Often, the solvent is used in an ultrasonic bath to provide additional energy in the removal of the unpolymerized material. Such solvents are not always necessary, since some unpolymerized photoreactive materials, such as CIBA® SL 5170, can be wiped cleanly away from their polymerized form without the use of any solvent.

Examples of other solvents that may be used to selectively rinse unpolymerized metal-containing photoreactive materials from those that are polymerized include, but are not limited to, casting solvents, such as those described above in relation to selection of a developer. For example, hexanes can be used for solubilizing and casting an unpolymerized metal-ligand complex of titanium (IV) diisopropoxide bis(ethyl acetoacetate), otherwise identified by the chemical formula Ti(i-PrO)₂(EAA)₂. Accordingly, hexanes can be chosen as the solvent to rinse the unpolymerized form of Ti(i-PrO)₂(EAA)₂ from its polymerized form. Likewise, since Ti(i-PrO)₂(EAA)₂ can also be cast in acetone or methyl isobutyl ketone (MIBK), these solvents are also effective rinsing solvents.

The metal-containing layer 305 may be formed on the stacked layers 301-304 using, for example, the method of photochemical/photothermal metal-organic deposition described above in relation to FIG. 1. Essentially, the stacked layers 301-304 are removed from stereolithography vat, rinsed with a solvent, and a precursor comprising at least one metal is first applied to the underlying layer 304 to form a precursor layer. A predetermined portion of the precursor layer is exposed to a source of energy, and the precursor layer is then developed to create the metal-containing layer 305, which is a pattern of metal-containing material. It should be appreciated that, as described above in relation to FIG. 1, the process can be designed such that either the exposed or unexposed regions of the metal-containing layer 305 are developed.

The metal-containing layer 305 may also be formed using, for example, the stereolithography apparatus method described above in relation to FIG. 2. Essentially, the stacked layers 301-304 are removed from a first vat, rinsed with a solvent, and placed in a second vat of photoreactive material comprising a metal-ligand complex. The metal-containing layer 305 is then formed directly on the underlying layer 304 in the second vat. The stacked layers 301-304 are lowered into the second vat, and the shape of the metal-containing layer 305 is traced with energy to polymerize the metal-ligand complex into the desired shape. The stacked layers 301-305 are then removed from the second vat, rinsed with a solvent and placed in back in the first vat to form a layer 306, which is complementary to the metal-containing layer 305.

Another metal-containing layer 307 can be formed on the layers 305 and 306 using either the photochemical/photothermal metal-organic deposition method or directly in a second vat using the stereolithography method. Other layers 308 through 315 are then added layer-by-layer to the stack using a combination of the above-described methods to form a three-dimensional layered structure 318.

It should be appreciated that rinsing stacked layers 301-304 prior to moving them to another vat avoids contamination of materials. Moreover, a solvent used to rinse the unpolymerized photoreactive material from the polymerized photoreactive material can also be considered a contaminant in another vat and should be chosen to minimize any adverse effects on the process that may be incurred as a result of such contamination. Preferably, a solvent used in the rinse step will either drain quickly away from stacked layers 301-304, dry quickly, facilitate a subsequent rinse with a faster drying solvent, and/or minimally affect the overall composition and performance of the photoreactive material in the vats.

The methods of the present invention can include applying a photoreactive material within a cavity of a three-dimensional layered structure. The number of process steps and the potential for contaminating vats of photoreactive material can be reduced by taking advantage of closed channels created during the manufacture of the three-dimensional layered structure. For example, a layer comprising a metal-ligand complex may be applied within a cavity of a three dimensional layered structure, thereby forming a pattern of metal-containing material corresponding to the shape of the cavity without having to take the steps necessary to transfer the three-dimensional layered structure to another vat. The closed channels should be able to contain the metal-ligand complex to avoid contamination of the other photoreactive material in the vat. Use of such a process would eliminate a series of rinsing and transfer steps. It should be appreciated that exposure of the metal-ligand complex to energy is optional where patterning of the material is unnecessary beyond the application of the material, since the metal-ligand complexes do not always require exposure to energy to be useful in the present invention.

The methods of the present invention can include interrupting the formation of layers to insert prefabricated components including, but not limited to, light-emitting diodes and batteries. For example, the photoreactive materials of the present invention may be used to create a three-dimensional layered structure that encases one or more prefabricated components. At least one layer comprising a metal-ligand complex is added to provide function to the structure by serving as a conducting material between the prefabricated components.

It should also be appreciated that the three-dimensional layered structure can consist entirely of layers comprising metal-ligand complexes. In one example, the entire structure may conduct electricity and serve, for example, as a component in the production of microelectromechanical devices (MEMs). In another example, the structure may conduct photons.

Optionally, the three-dimensional layered structure is subject to post-curing, or post-exposure, to complete solidification of the photoreactive material. This may be necessary, as the energy used to form the structure may not be powerful enough to completely solidify the photoreactive material in the given exposure time. Although the post-exposure can be accomplished by any source of energy capable of solidifying the photoreactive material, UV fluorescent light and heat are preferred energy sources.

Optionally, the three-dimensional layered structure is subject to a finishing step. This may be necessary, since the shape resolution may not be suitable for a particular use. For example, a finishing step would be necessary for a use that requires a striking appearance and/or a function that is associated with the fit and form of the shape. There are generally five different levels of finish recognized in the art: (1) a pattern finish requires no treatment; (2) a finish for engineering review may require light sanding and bead blasting to achieve an industry standard finish where layering is still apparent, but the finish is sufficient for testing fit and form; (3) a presentation model finish requires sanding until smooth and may optionally include priming the finish; (4) a trade show finish requires sanding until smooth, priming and painting; and (5) a special finish requires polishing until the finish is glassy.

It should also be appreciated that the number, orientation and shape of the layers shown in FIG. 3 were chosen for purposes of illustration only and not for purposes of limiting the present invention. Indentations 316 and 317 are an example of a simple variation in dimension that can be introduced to provide a fit between structure 318 and some complementary structure. The methods of the present invention can form a desired three-dimensional layered structure of nearly any number, orientation and shape of layers and thus can form nearly any three-dimensional structure.

The invention has been described above. The following Examples are presented to illustrate ways of forming a metal-containing layer and, in particular, forming a layer using photochemical/photothermal metal-organic deposition, rather than to limit the scope of the invention:

### EXAMPLE 1

Titanium (IV) diisopropoxide bis(ethyl acetoacetate), otherwise identified by the chemical formual Ti(i-PrO)₂(EAA)₂, was synthesized by dissolving 2.9410 g titanium (IV) isopropoxide (97%, Aldrich) in 2.0100 g isopropanol to form a solution. A sample of 2.6213 g ethyl acetoacetate (99%, Aldrich) was added to the solution, and the solution was stirred for 2 hours at room temperature. Volatiles were allowed to evaporate from the resulting mixture at room temperature, and the product Ti(i-PrO)₂(EAA)₂ was a sticky orange liquid.

A sample of 0.1017 g Ti(i-PrO)₂(EAA)₂ was dissolved in 0.3132 g methyl isobutyl ketone, otherwise known as MIBK, to make a precursor solution. A precursor film was formed on a silicon substrate by spin-coating. The film was exposed to UV radiation with a wavelength of 254 nm through a mask for 5 minutes to form a predetermined pattern of exposed regions. After dipping the coated substrate in hexanes and drying the film with compressed air, the film was developed using isopropanol as the developer. The developer removed the predetermined pattern of exposed regions to create the positive pattern of unexposed material.

### EXAMPLE 2

The extent of exposure was tested by repeating the process in Example 1 using exposure times of 2, 3, 5, 7 and 12 minutes. As the exposure time increased, the exposed region became more difficult to remove with the developer, and the material that was converted using 12 minutes of exposure time was no longer soluble in the developer. As such, exposure time was found to be an important variable such that too much exposure will result in a negative lithographic image rather than the positive lithographic image. Thus, the desired pattern will not be obtainable with too much exposure since the converted material will no longer be soluble in the developer.

### EXAMPLE 3

The process of Example 1 was repeated using hexanes as the casting solvent and acetone as the developer. A positive pattern was successfully obtained.

It was observed that Ti(i-PrO)₂(EAA)₂ could be dissolved in both polar and nonpolar casting solvents. Application of Ti(i-PrO)₂(EAA)₂ using a polar casting solvent resulted in sticky and dirty films, whereas the use of a nonpolar casting solvent resulted in clean and dry films.

The use of polar casting solvents such as acetone and MIBK resulted in precursor films that could only be slightly redissolved by nonpolar solvents such as hexanes. Likewise, the use of nonpolar solvents as casting solvents resulted in precursor films that could only be slightly redissolved by polar solvents.

### EXAMPLE 4

A titanium-containing precursor was synthesized by dissolving 0.2937 g titanium (IV) isopropoxide in 2.1093 g ethanol to form a solution. A sample of 0.2258 g lactic acid was added to the solution to make a precursor solution. After allowing 24 hours for the precursor solution to stabilize, a titanium precursor film was formed by spin-coating the precursor solution on a silicon substrate. A predetermined portion of the film was exposed to the output of a low pressure mercury lamp using exposure times of 0.5, 1, 2, 3, 4, 5, 7 and 10 minutes. Developing the film with acetone gave a positive pattern with each exposure time, and at an exposure time of 1 minute, the unexposed region of the film was largely unaffected by development. Developing the film with ethanol, however, removed the unexposed regions and, thus, produced a negative image.

### EXAMPLE 5

An important feature of the invention is the ability to obtain highly resolved patterns. The process of Example 1 was repeated using iron tetracarbonyl triphenylphosphine, otherwise identified by the chemical formula Fe(CO)₄PPh₃, and the casting solvent was methylene chloride. The sample was exposed to the output of a low pressure mercury lamp for 30 minutes through a chromium optical mask to form the predetermined pattern. The exposed region was developed by immersing the sample in water. The water removed the predetermined pattern of exposed regions to create a positive pattern with a feature size of 4 microns.

### EXAMPLE 6

A sample of Mn(II) 2-ethylhexanoate, otherwise identified by the chemical formula Mn(II)(CH₃(CH₂)₃CH(C₂H₅)COO)₂, was dissolved in hexanes to make a precursor solution. A precursor film was formed on a silicon substrate by spin-coating. The film was exposed to UV radiation under a Mineralite lamp for 17 hours to form a predetermined pattern. The film was developed using water as the developer. The developer removed the exposed regions to create the positive pattern. The positive pattern could then be further converted to a film containing manganese oxide using, for example, a post-exposure dose of energy from an electromagnetic source such as a source of heat and/or light.

### EXAMPLE 7

A sample of tungsten pentacarbonyl triphenylphosphine, otherwise identified by the chemical formula W(CO)₅PPh₃, was dissolved in methylene chloride to make a precursor solution. A precursor film was formed on a silicon substrate by spin-coating. The film was exposed to UV radiation under a Mineralite lamp for 17 hours to form a predetermined pattern. The film was developed using water as the developer. The developer removed the exposed regions to create the positive pattern. The positive pattern could then be further converted to a film containing tungsten oxide using, for example, a post-exposure dose of energy from an electromagnetic source such as a source of heat and/or light.

### EXAMPLE 8

A sample of Ni(II) 2-ethylhexanoate, otherwise identified by the chemical formula Ni(II)(CH₃(CH₂)₃CH(C₂H₅)COO)₂, was dissolved in MIBK to make a precursor solution. A precursor film was formed on a silicon substrate by spin-coating. The film was exposed to UV radiation under a Mineralite lamp for 22 hours to form a predetermined pattern. The film was developed using water as the developer. The developer removed the exposed regions to create the positive pattern. The positive pattern could then be further converted to a film containing nickel oxide using, for example, a post-exposure dose of energy from an electromagnetic source such as a source of heat and/or light.

### EXAMPLE 9

A sample of Silver (I) trifluoroacetylacetonate, otherwise identified by the chemical formulas Ag(I)(CH₃(CO)CH(CO)CF₃) and Ag(I)(tfacac), was dissolved in 1.0059 g anhydrous ethanol to make a precursor solution. A precursor film was formed on a silicon substrate by spin-coating. The film was exposed to UV radiation with a wavelength of 254 nm through a mask for 12 minutes to form a predetermined pattern of exposed regions. The sample was left in the dark for 80 minutes, and silver oxide formed in the unexposed regions of the film. Developing the film with cyclohexanol for 20 seconds gave a positive pattern.

### EXAMPLE 10

A mixture of precursors was formed by first dissolving 0.0516 g titanium (IV) diisopropoxide bis(2,4-pentanedionate) in 0.5002 g MIBK and adding 0.0464 g titanium (IV) diisopropoxide bis(ethyl acetoacetate) to make the mixed precursor solution.

A precursor film was formed on a silicon substrate by spin-coating. The film was exposed to the output of a low pressure mercury lamp in a predetermined pattern formed by transmitting the output through a mask placed on the film. Exposure times of 4, 4.5, 7.5, 8 and 9 minutes were used. Developing the film with water gave a positive pattern with each exposure time.

While the foregoing description and drawings represent the preferred embodiments of the present invention, it will be understood that various additions, modifications and substitutions may be made therein without departing from the spirit and scope of the present invention as defined in the accompanying claims. In particular, it will be clear to those skilled in the art that the present invention may be embodied in other specific forms, structures, arrangements, proportions, and with other elements, materials, and components, without departing from the spirit or essential characteristics thereof. The presently disclosed embodiments are therefore to be considered in all respects as illustrative and not restrictive, the scope of the invention being indicated by the appended claims, and not limited to the foregoing description.

For example, although the invention has been described using a film comprising a metal-ligand complex containing titanium, it is to be understood that other metals or combinations of metals may be used. Moreover, although the invention has been described as using certain solvents for casting, rinsing and developing, it is to be understood that other solvents may be used. For example, both water and isopropanol have been described as developers but one of skill in the art would recognize other developers may be equally effective or more preferred due to other process considerations.

1. A method of layered manufacturing, comprising:
sequentially forming each of a plurality of layers, wherein each layer of the plurality of layers has predetermined dimensions, and wherein at least one of the layers comprises a metal-containing material; and
stacking each of the plurality of layers to create an integral three-dimensional layered structure with predetermined dimensions.

2. The method of claim 1, further comprising rinsing the three-dimensional layered structure to remove excess material comprising the metal-containing material.

3. The method of claim 1, further comprising post-exposing the three-dimensional layered structure.

4. The method of claim 1, 2 or 3, further comprising finishing the three-dimensional layered structure.

5. The method of claim 1, wherein the at least one layer comprising a metal-containing material is formed by a process comprising:
applying a precursor comprising at least one metal on a substrate to form a precursor layer;
exposing a predetermined portion of the precursor layer; and
developing the precursor layer, thereby creating a pattern of metal-containing material comprising a remaining portion of the precursor.

6. The method of claim 1, wherein the at least one layer comprising a metal-containing material is formed by a process comprising:
dipping a platform into a vat of precursor material to a predetermined depth, thereby forming a precursor layer of a predetermined thickness, wherein the precursor layer of a predetermined thickness may optionally be formed on an underlying layer on the platform;
exposing a predetermined portion of the precursor layer, thereby creating a pattern of metal-containing material; and
rinsing unexposed precursor material from the pattern of metal-containing material.

7. The method of claim 1, wherein the at least one layer comprising a metal-containing material is formed by a process comprising
applying a precursor comprising at least one metal within a cavity of a three-dimensional layered structure, thereby forming a pattern of metal-containing material in the shape of the cavity; and
optionally exposing the pattern of metal-containing material.

8. The method of claim 1, wherein the at least one layer comprising a metal-containing material comprises a molecular metal-ligand complex.

9. The method of claim 8, wherein the metal-ligand complex comprises particles in contact with at least one ligand.

10. The method of claim 9, wherein the particles comprise sol particles.

11. The method of claim 9, wherein the particles comprise microparticles.

12. The method of claim 9, wherein the particles comprise nanoparticles.

13. The method of claim 9, wherein the particles comprise ceramics.

14. The method of claim 9, wherein the particles comprise alloys.

15. The method of claim 10, further comprising transforming the metal-ligand complex into a gel.

16. The method of claim 5 or 6, wherein said exposing comprises photochemically reacting, photothermally reacting and combinations thereof.

17. The method of claim 16, wherein said exposing comprises radiating the predetermined portion of the precursor layer with electromagnetic radiation.

18. The method of claim 17, wherein the electromagnetic radiation comprises ultraviolet radiation.

19. The method of claim 5, wherein said developing comprises contacting the predetermined portion with a polar solvent.

20. The method of claim 5, wherein said developing comprises contacting the predetermined portion with a protic solvent.

21. The method of claim 5, further comprising pre-exposing the precursor layer to energy before said exposing.

22. The method of claim 21, wherein said pre-exposing comprises photochemically reacting, photothermally reacting and combinations thereof.

23. The method of claim 22, wherein the pre-exposing comprises radiating the predetermined portion of the precursor layer with electromagnetic radiation.

24. The method of claim 23, wherein the electromagnetic radiation comprises ultraviolet radiation.

25. The method of claim 21, wherein the pre-exposing further comprises selecting a predetermined fraction of a minimum energy necessary for developing the predetermined portion of the precursor.

26. The method of claim 21, further comprising post-exposing the precursor to energy after said exposing.

27. The method of claim 5 further comprising post-exposing the precursor to energy after said exposing.

28. The method of claims 26 or 27, wherein said post-exposing comprises photochemically reacting, photothermally reacting and combinations thereof.

29. The method of claims 26 or 27, wherein the post-exposing comprises radiating the predetermined portion of the precursor layer with electromagnetic radiation.

30. The method of claim 26 or 27, wherein the electromagnetic radiation comprises ultraviolet radiation.
